(19) United States
(12) Patent Application Publication
(10) Pub. No.: US 2025/0287456 A1
(43) Pub. Date: Sep. 11, 2025

(54) METHODS TO ENHANCE THE ENERGY SAVING CAPABILITIES FOR THE UE AFTER DL DATA RECEPTION IN MT-SDT

(71) Applicant: Telefonaktiebolaget LM Ericsson (publ), Stockholm (SE)

(72) Inventors: Revathy Narayanan, Sollentuna (SE); Andreas Höglund, Solna (SE); Oskar Myrberg, Norrköping (SE); Jan Christoffersson, Luleå (SE); Hamza Khan, Helsinki (FI); Henrik Enbuske, Stockholm (SE); Stefan Wänstedt, Luleå (SE); Emre A. Yavuz, Stockholm (SE); Tuomas Tirronen, Helsinki (FI)

(21) Appl. No.: 18/861,888

(22) PCT Filed: May 2, 2023
(86) PCT No.: PCT/SE2023/050418

§ 371 Date: Oct. 31, 2024

Related U.S. Application Data
(60) Provisional application No. 63/337,546, filed on May 2, 2022.

(51) Int. Cl. H04W 76/28; H04W 68/00

(52) U.S. Cl. CPC H04W 76/28; H04W 68/005

(57) ABSTRACT

Systems and methods for implementing Discontinuous Reception (DRX) are provided. In some embodiments, a method performed by a User Equipment (UE) for implementing DRX includes: configuring a DRX scheme which is activated in certain conditions; implementing DRX at the UE during one or more of the group consisting of: from the time the UE receives an RRCRelease message; after the UE receives DL data; and until terminating a (MT-SDT) session. This can result in significant energy benefits at the UE end. Some embodiments enable DRX during the MT-SDT procedure. The advantage of the solution is reduced energy consumption by the UE by saving the energy spent by enabling DRX in the MT-SDT procedure.

### RELATED APPLICATIONS

This application claims the benefit of provisional patent application Ser. No. 63/337,546, filed May 2, 2022, the disclosure of which is hereby incorporated herein by reference in its entirety.

### TECHNICAL FIELD

The current disclosure relates generally to implementing Discontinuous Reception (DRX).

### BACKGROUND

In Rel-15, 3GPP introduced a new radio-access technology known as NR (New Radio). The technology was further enhanced in release 16 and will continue to evolve in release 17 and later. In NR, the device can be in RRC idle, in RRC connected or in RRC inactive state. Until release 16, the data transmission was possible only in RRC connected. Therefore, UE must be moved to a connected state from idle or inactive states every time there is data to be transferred between UE and gNB. This leads to significant signaling overhead and power consumption, in particular for UEs that needs infrequent transmission of small data packets. In inactive state, the UE has established RRC context and core network connection. Therefore, the transition from inactive to connected state is relatively fast and requires less signaling, compared to the transition from idle to connected.

There currently exist certain challenge(s). Improved methods and systems for implementing Discontinuous Reception (DRX) are needed.

### SUMMARY

Systems and methods for implementing Discontinuous Reception (DRX) are provided. In some embodiments, a method performed by a User Equipment (UE) for implementing DRX includes: configuring a DRX scheme which is activated in certain conditions; implementing DRX at the UE during one or more of the group consisting of: from the time the UE receives an RRCRelease message; after the UE receives DL data; and until terminating a (MT-SDT) session. This can result in significant energy benefits at the UE end. Some embodiments enable DRX during the MT-SDT procedure. The advantage of the solution is reduced energy consumption by the UE by saving the energy spent by enabling DRX in the MT-SDT procedure.

In some embodiments, the DRX configuration is applied from the time the UE receives the RRCRelease message until the connection is closed. In some embodiments, the DRX configuration is carried in the RRCRelease message. In some embodiments, the DRX configuration is applied from the time the first DL data is received by the UE.

In some embodiments, the DRX configuration is carried in a RRCmessage. In some embodiments, the RRCmessage is new. In some embodiments, the RRCmessage is multiplexed with the MAC PDU carrying the DL data. In some embodiments, the DRX configuration is part of System Information (SI). In some embodiments, the DRX configuration is contained in the UE context which was saved the previous time when the UE was sent to inactive state.

In some embodiments, the UE adjusts its DRX preferences based on its energy-related or traffic-related conditions.

In some embodiments, the method further includes: informing the network of the adjusted DRX preferences. In some embodiments, the DRX preferences are based on one or more parameters such as: the UEs battery status and/or latency preferences.

In some embodiments, the DRX preferences are based on one or more parameters such as: the expected or historical behavior of the application, and the traffic patterns generated.

In some embodiments, wherein UEAssistanceInformation is sent to a network node either: multiplexed with the RRCResumeRequest; or in a scheduled transmission after the reception of the first DL data.

In some embodiments, sending of UEAssistanceInformation is triggered by introducing an added bit along with DL data.

In some embodiments, the RRCRelease contains an acknowledgement of the preferred DRX configuration. In some embodiments, the RRCRelease contains the DRX configuration.

In some embodiments, the method also includes: receiving an indication on the handling or status of DRX timers related to a DRX configuration.

In some embodiments, the indication comprises one or more of the group consisting of: not starting the DRX inactivity timer after receiving the DL transmission that includes the indication; starting, with a zero duration, the DRX inactivity timer after receiving the DL transmission that includes the indication; and an alternative onDuration related to a single or alternative SDT DRX configuration.

In some embodiments, the DRX configuration is provided by the network node in RRC Release. In some embodiments, the DRX configuration is triggered to be activated by the UE during the MT-SDT procedure. In some embodiments, the UE is configured to always use DRX during MT-SDT. In some embodiments, the DRX configuration to be used is the same DRX configuration used in RRC_CONNECTED. In some embodiments, a new DRX configuration is to be used only during the MT-SDT procedure or during the steps while waiting for the connection to be closed.

In some embodiments, the method also includes: moving to idle mode as soon as the UE transmits the HARQ ACK in the uplink. In some embodiments, the method also includes: the network node indicating to the UE that when it is for SDT, the UE may assume that it would be enough to respond with HARQ ACK in the uplink before moving to idle mode. In some embodiments, such indication is provided along with the indication for MT-SDT in the paging message or in the control channel that schedules the paging message.

In some embodiments, the indication is provided in one or more of: MSG2 if it would be possible for the network to know that connection to be established is for MT-SDT; as part of the system information broadcast in the serving cell; and in MSG4, which can be either in the MAC sub-header or the RRCRelease part of the message.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of baseline procedures for Random Access (RA)-Small Data Transmission (SDT);

FIG. 2 illustrates an example of baseline procedures for Configured Grant (CG)-SDT;

FIG. 3 illustrates an example where a User Equipment (UE) needs to keep checking for further Uplink (UL) grants and Downlink (DL) assignments from the gNB side;

FIG. 4A illustrates method performed by a UE for implementing Discontinuous Reception (DRX) in accordance with some embodiments;

FIG. 4B illustrates method performed by a network node for implementing DRX in accordance with some embodiments;

FIG. 4C illustrates an embodiment where the DRX configuration is applied from the time the UE receives the RRCRelease message until the connection is closed in accordance with some embodiments;

FIG. 5 illustrates an embodiment where the DRX configuration is applied from the time the first DL data is received by the UE in accordance with some embodiments;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host, which may be an embodiment of the host of FIG. 6, in accordance with various aspects described herein;

FIG. 10 is a block diagram illustrating a virtualization environment in which functions implemented by some embodiments may be virtualized; and

FIG. 11 shows a communication diagram of a host communicating via a network node with a UE over a partially wireless connection in accordance with some embodiments.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). A Work Item RP-200954 ‘New Work Item on NR small data transmissions in INACTIVE state’ has been approved in 3GPP Rel-17 with the focus of optimizing the transmission for small data payloads by reducing the signaling overhead. The WI contains the following relevant objectives:

```
This work item enables small data transmission in RRC_INACTIVE state as follows:
- For the RRC_INACTIVE state:
      ○ UL small data transmissions for RACH-based schemes (i.e., 2-step and 4-step
          RACH):
            ▪ General procedure to enable UP data transmission for small data packets
                from INACTIVE state (e.g., using MSGA or MSG3) [RAN2]
            ▪ Enable flexible payload sizes larger than the Rel-16 CCCH message size
                that is possible currently for INACTIVE state for MSGA and MSG3 to
                support UP data transmission in UL (actual payload size can be up to
                network configuration) [RAN2]
            ▪ Context fetch and data forwarding (with and without anchor relocation) in
                INACTIVE state for RACH-based solutions [RAN2, RAN3]
            Note 1: The security aspects of the above solutions should be checked with
            SA3
      ○ Transmission of UL data on pre-configured PUSCH resources (i.e., reusing the
          configured grant type 1) − when TA is valid
            ▪ General procedure for small data transmission over configured grant type
                1 resources from INACTIVE state [RAN2]
            ▪ Configuration of the configured grant typel resources for small data
                transmission in UL for INACTIVE state [RAN2]
```

The Small Data Transmission (SDT) procedure in NR Rel-17 is only for MO-SDT (Mobile Originated) SDT meaning that it is only triggered by UL data transmissions.

For NB-IoT and LTE-M similar signaling optimizations for small data have been introduced through Rel-15 Early Data Transmission (EDT) and Rel-16 Preconfigured Uplink Resources (PUR). The main differences for the NR SDT solutions are that the Rel-17 NR Small Data is only to be supported for RRC INACTIVE state, includes also 2-step RACH based small data, and that it should also include regular complexity MBB UEs. Both support MO traffic only. NR SDT is also unlike LTE EDT in support transmission of subsequent data, which is larger payload sizes which require more than one transmission.

RA-SDT means that either legacy 4-step RACH (or 2-step RACH) procedure is used as a baseline but that a user-plane data payload can be appended (multiplexed with the RRCResumeRequest message) in Msg3 (or MsgA). CG-SDT means that the UEs configured via RRC to have periodic CG-SDT occasions which can, contention-free, be used for uplink transmission. In this way Msg1 and Msg2 can be omitted but it is a requirement that the UE has a valid Timing Advance (TA) and is uplink synchronized to be able to use the resources for transmission.

### Transmission of UL Data on Pre-Configured PUSCH Resources, the MO CG-SDT Procedure

The CG-SDT procedure uses CG PUSCH resources that are PUSCH resources configured in advance for the UE. When there is uplink data available at UE's buffer, it can immediately start uplink transmission using the pre-configured PUSCH resources without waiting for an UL grant from the gNB, thus reducing the latency. NR supports CG type 1 PUSCH transmission and CG type 2 PUSCH transmission. For both two types, the PUSCH resources (time and frequency allocation, periodicity, etc.) are preconfigured via dedicated RRC signaling. The CG type 1 PUSCH transmission is activated/deactivated by RRC signaling, while the CG type 2 PUSCH transmission is activated/deactivated by an UL grant using Downlink Control Information (DCI) signaling. For Small Data transmissions, it has been agreed that the CG type 1 is used.

According to the RAN2 agreements for CG-SDT, the CG-SDT configuration will be sent to the UE in the RRCRelease message and will specify associations between CG resources (transmission opportunities) and SSBs. The UE will upon initiating the CG-SDT procedure select an SSB with SS-RSRP above a configured RSRP threshold. The initial CG-SDT transmission will contain the RRCResumeRequest multiplexed with data and possibly a BSR MAC CE and possibly a PHR MAC CE. If the gNB receives the transmission successfully it will reply with dynamic scheduling of uplink new transmission for the same HARQ process as acknowledgement or possibly with a DL data transmission. After this the UE may use the following CG-SDT resources for transmission of new UL data after successful TA validation and SSB selection. The TA validation means that the CG-SDT TA timer is running and the change of the SS-RSRP(s) are within configured thresholds. The CG-SDT procedure is terminated when the CG-SDT-TA timer expires, the UE reselects to a different cell or the gNB sends a RRCResume or RRCRelease to the UE.

For LTE support for mobile terminated traffic (MT) was introduced later in Rel-16, that is supporting transmissions of small data payloads in the downlink.

NR MT-SDT is being introduced in Rel-18. A Rel-18 MT-SDT work item description (WID) was approved in RAN #94e (December 2021) and can be found in RP-213583. The WID contains the following objectives:

```
Specify the support for paging-triggered SDT (MT-SDT) [RAN2, RAN3]
  • MT-SDT triggering mechanism for UEs in RRC_INACTIVE, supporting RA-SDT
      and CG-SDT as the UL response;
  • MT-SDT procedure for initial DL data reception and subsequent UL/DL data
transmissions in RRC_INACTIVE.
Note: Data transmission in DL within paging message is not in scope of this WI.
```

The exact procedure is to be defined but a probable baseline can be expected to be as follows:
1. DL data triggers an MT-SDT procedure in the network
2. Network pages UE
3. UE responds to the paging by initiating an SDT procedure, either CG-SDT or RA-SDT. This means that the UE sends an RRCResumeRequest message.
4. The NW (after contention resolution in case of RA-SDT) schedules a DL transmission including the data that triggered the MT-SDT procedure.
5. The UE may optionally acknowledge the DL transmission.
6. The NW either moves the UE to connected mode or releases the UE to Idle or Inactive mode.

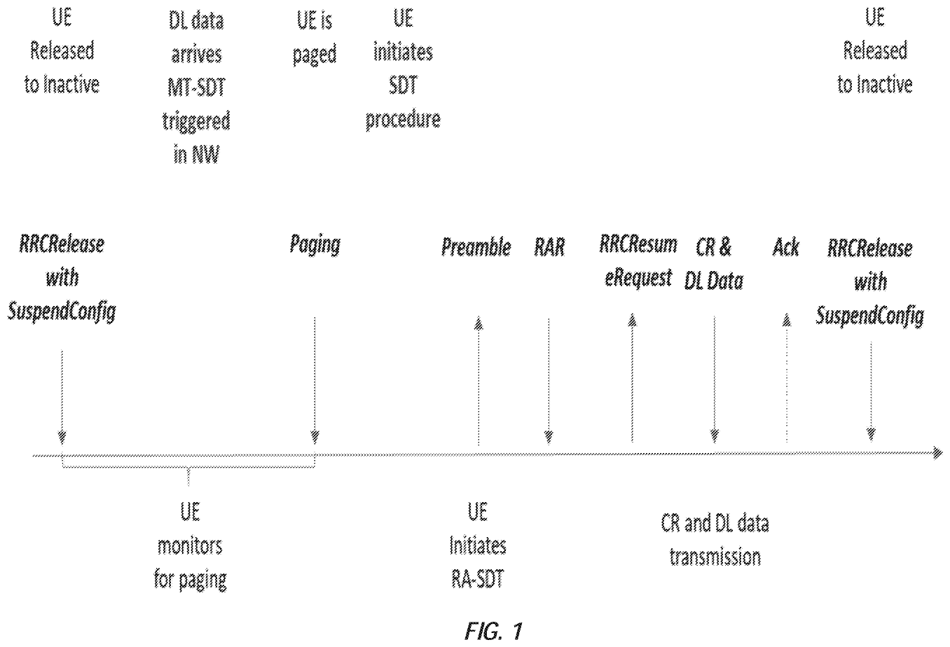

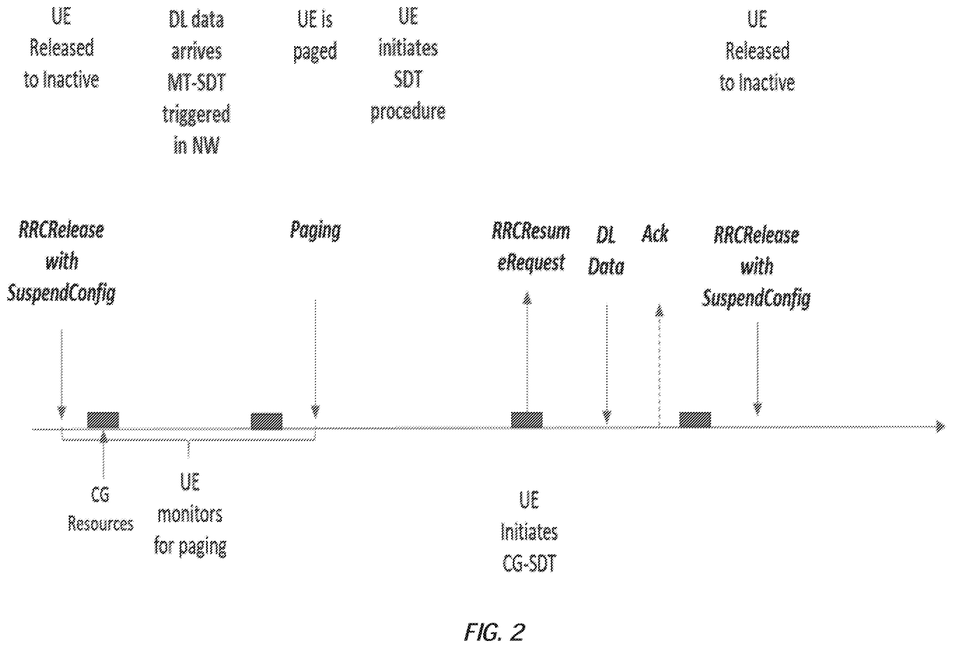

An example of baseline procedures for RA-SDT is shown in FIG. 1 and for CG-SDT in FIG. 2.

Rel-18 MT-SDT is a 3GPP feature with the target to reduce the overall signaling overhead and UE energy consumption. The overall skeleton of MT-SDT involves an initial paging trigger followed by a data transmission DL and an optional UL transmission in response. This “connection” is further terminated when the gNB sends an RRCRelease RRC message after which the UE waits for a while and then closes the connection (e.g., in case the HARQ ACK is lost in uplink and gNB retransmits the RRCRelease). During the time from receiving the RRCRelease and closing the connection, the UE monitors PDCCH for DL assignments and UL grants which will cause the UE to spend unnecessary energy.

Based on TS 38.331, the waiting period of the UE once it receives RRCRelease could be up to 60 ms. The snippet of the same is stated below.

The UE shall:

1> delay the following actions defined in this sub-clause 60 ms from the moment the RRCRelease message was received or optionally when lower layers indicate that the receipt of the RRCRelease message has been successfully acknowledged, whichever is earlier;

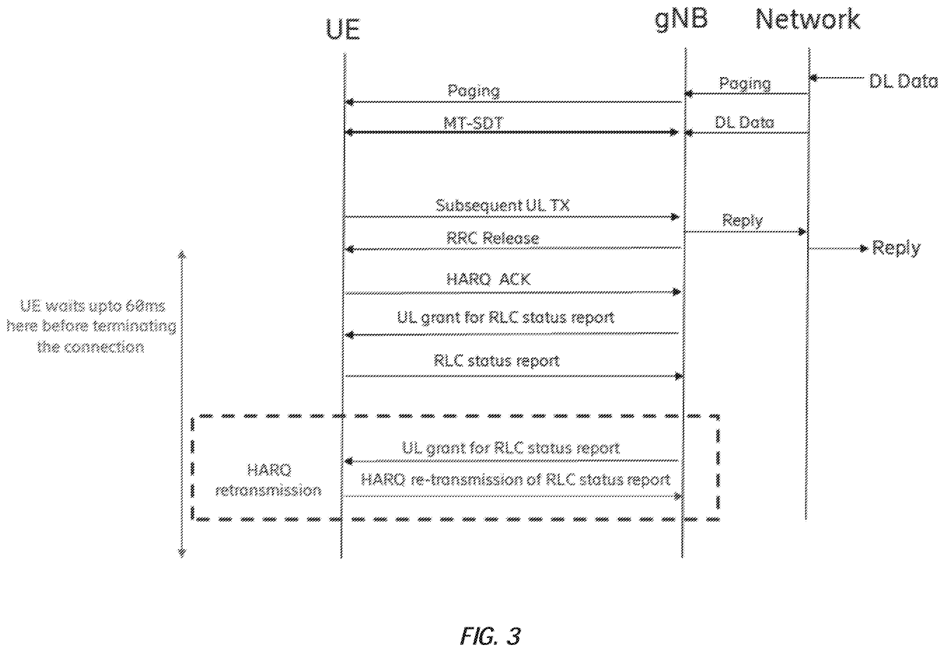

This waiting is generally for the UE to send its RLC status report to the gNB before closing the connection. However, during this waiting period, the UE needs to keep checking for further UL grants and DL assignments from the gNB side (as shown in FIG. 3). The absence of further UL grants indicates the UE that the RLC status report has been successfully obtained by the gNB. This results in considerable energy wastage for the UE.

Certain aspects of the disclosure and their embodiments may provide solutions to these or other challenges.

Systems and methods for implementing Discontinuous Reception (DRX) are provided. In some embodiments, a method performed by a UE for implementing DRX includes: configuring a DRX scheme which is activated in certain conditions; implementing DRX at the UE during one or more of the group consisting of: from the time the UE receives an RRCRelease message; after the UE receives DL data; until terminating a MT-SDT session.

Some embodiments propose implementing DRX at the UE from the time the UE receives the RRCRelease message or after the UE receives DL data until terminating the MT-SDT session. While this adds scheduling restrictions to the gNB end, this can result in significant energy benefits at the UE end.

Alternatively, some embodiments also propose an option for the UE to switch back to idle mode immediately after sending a HARQ-ACK in response to the receipt of RRCRelease message.

Some embodiments enable DRX during the MT-SDT procedure. The general procedure is to configure a DRX scheme which is activated in certain conditions. The advantage of the solution is reduced energy consumption by the UE by saving the energy spent by enabling DRX in the MT-SDT procedure.

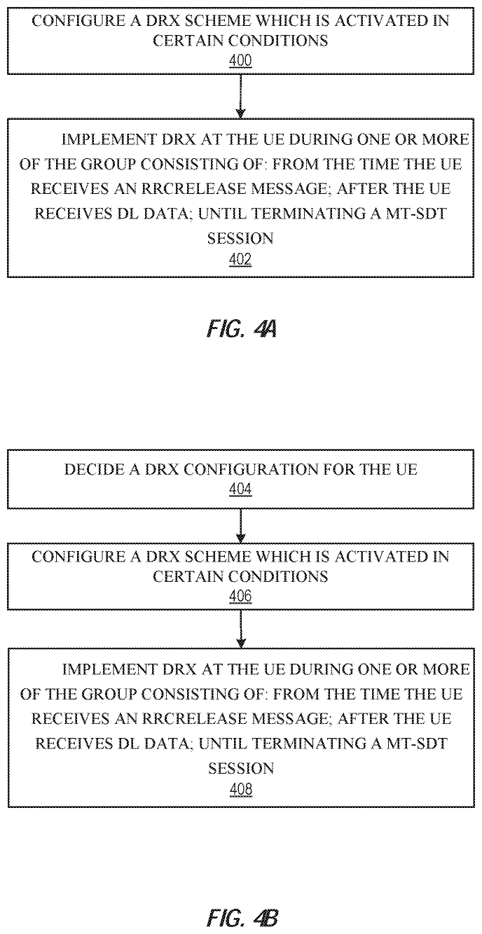

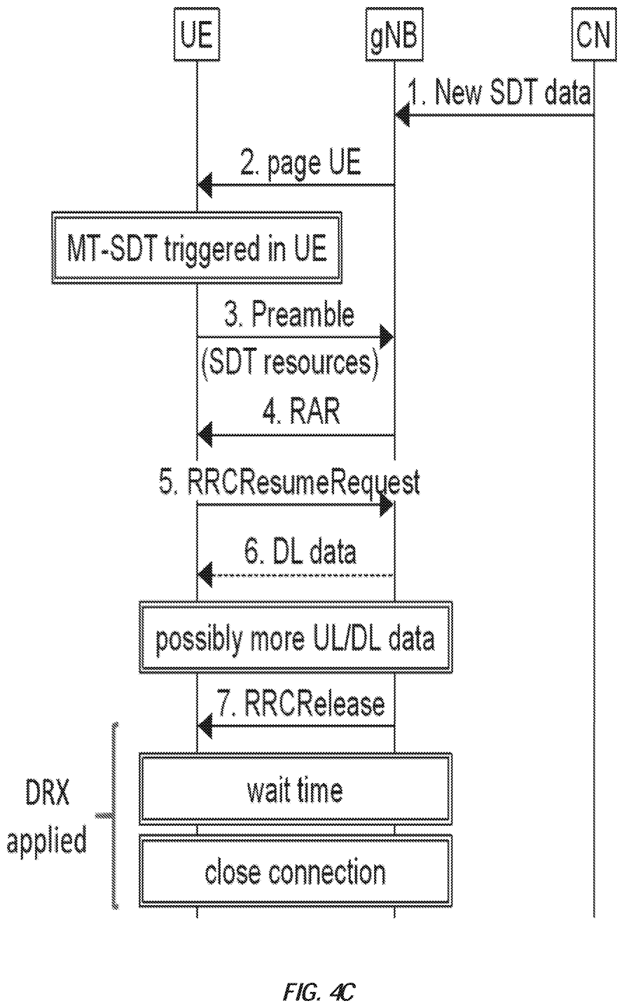

FIG. 4A illustrates method performed by a UE for implementing DRX in accordance with some embodiments. In some embodiments, the UE configures (step 400) a DRX scheme which is activated in certain conditions. The UE implements (step 402) DRX during one or more of: from the time the UE receives an RRCRelease message; after the UE receives DL data; and until terminating a MT-SDT session.

FIG. 4B illustrates method performed by a network node for implementing DRX in accordance with some embodiments. In some embodiments, the network node decides (step 404) a DRX configuration for the UE. The network node configures (step 406) the DRX scheme which is activated in certain conditions. The DRX is implemented (step 408) at the UE during one or more of: from the time the UE receives an RRCRelease message; after the UE receives DL data; and until terminating a MT-SDT session.

In some embodiments, closing a connection means that the UE stops monitoring the PDCCH and perform the actions upon receiving the RRCRelease message according to 38.331. Some embodiments include several embodiments detailed as follows.

Embodiments on when to apply DRX:

In a first embodiment, the DRX configuration is applied from the time the UE receives the RRCRelease message until the connection is closed. This is illustrated in FIG. 4C. In one option of this embodiment, the DRX configuration, i.e., the DRX-Config information element, is carried in the RRCRelease message. In another option, the DRX configuration is part of system information (SI). As another option, the DRX configuration is contained in the UE context which was saved the previous time when the UE was sent to inactive state.

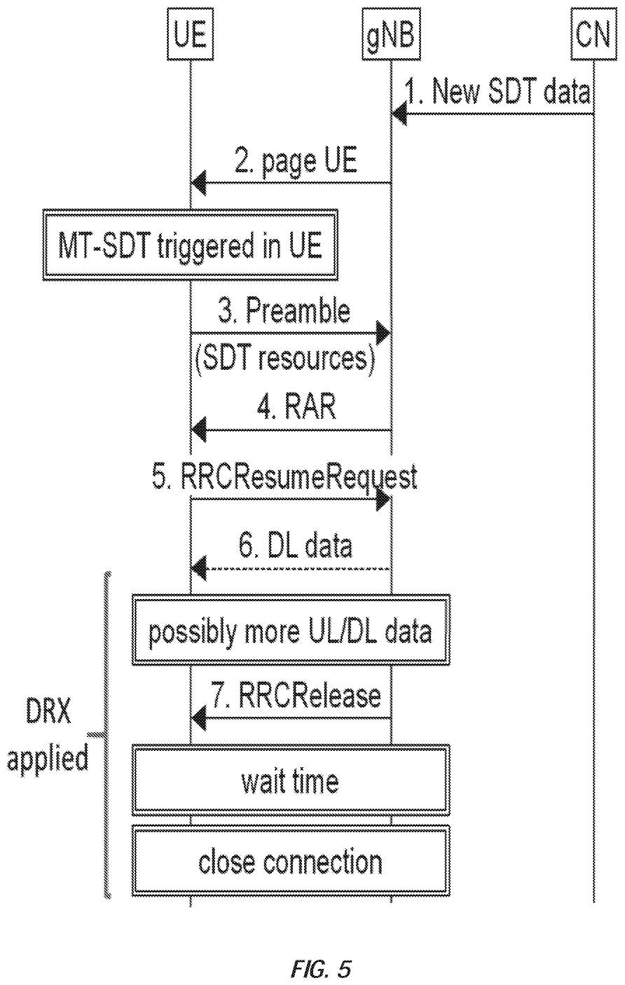

In second embodiment, the DRX configuration is applied from the time the first DL data is received by the UE. This is illustrated in FIG. 5. In this case, the DRX configuration can be carried in a, possibly new, RRCmessage which can be multiplexed with the MAC PDU carrying the DL data. As one option, the DRX configuration is part of SI. As another option, the DRX configuration is contained in the UE context which was saved the previous time when the UE was sent to inactive state.

### Embodiments on Configuring DRX Parameters

The UE can optionally adjust its DRX preferences based on its energy related or traffic related conditions and inform them to the network as part of UEAssistanceInformation. In one embodiment, the energy-related DRX preferences can be based on parameters such as the UEs battery status or latency preferences—e.g., a UE may prefer very low energy consumption at the expense of increased latency. In another embodiment, the expected or historical behavior of the application, i.e., the traffic patterns generated can be used as input for the preferred DRX setting of the device.

This optional DRX preference update in the UEAssistanceInformation can be sent to the gNB either multiplexed with the RRCResumeRequest or in a scheduled transmission after the reception of the first DL data. Alternatively, sending of UEAssistanceInformation can be triggered by introducing an added bit along with DL data. As a third option, the RRCRelease can contain an acknowledgement of the preferred DRX configuration in the UEAssistanceInformation message.

As a different embodiment, the RRCRelease contains the DRX configuration. In this case, the DRX configuration is decided by the gNB and can be based on the actual traffic and keeping the UE's energy saving in mind. The gNB adjusts its UL grant scheduling based on the DRX preferences at the UE. As an example, out of the total 60 ms the UE keeps for waiting for further UL grants from the gNB after RRCRelease, the UE can adjust its preferences to wake up every 10 ms to check for the UL grant. The gNB now schedules further UE UL grants accordingly.

In an alternative embodiment, an indication can be included as part of providing a DRX configuration as described above, e.g., in RRCRelease, or as a following indication e.g., DCI or MAC CE, which may instruct the UE on the handling or status of DRX timers related to a DRX configuration. For example, the indication may let the UE to not start (alt. start w 0 duration) the DRX inactivity timer after receiving the DL transmission that includes the indication. Alternatively, or additionally, the indication may indicate an alternative onDuration related to a single or alternative SDT DRX configuration.

In one embodiment, the DRX configuration is provided by the gNB in RRC Release (or another RRC message) during a previous connection (or when ending the previous connection). It is triggered to be activated by the UE during the MT-SDT procedure using signaling from the gNB, for example, by using a DCI, MAC CE or RRC signaling or another form signaling. In one alternative the UE is configured to always use DRX during MT-SDT e.g., through dedicated RRC configuration or broadcast system information.

In an embodiment the DRX configuration to be used is the same DRX configuration used in RRC_CONNECTED, alternatively a new configuration to be used only during the MT-SDT procedure or during the steps while waiting for the connection to be closed, as discussed above.

### UE Moving to IDLE Mode as an Alternative Solution

In contrast to the DRX based solutions, an alternative proposal is for the UE to move to idle mode as soon as it transmits the HARQ ACK in the uplink such as the case for NB-IoT and LTE-M devices. For example, gNB can indicate to the UE that when it is for SDT, UE may assume that it would be enough to respond with HARQ ACK in the uplink before moving to idle mode, e.g., without waiting further in case it receives a request for PDCP status report.

In one embodiment, such indication is provided along with the indication for MT-SDT in the paging message or in the control channel that schedules the paging message.

In a second embodiment, the indication is provided in MSG2 if it would be possible for the network to know that connection to be established is for MT-SDT, e.g., in case the UE uses preambles that are reserved for MT-SDT.

In another embodiment, the indication is provided as part of the system information broadcast in the serving cell.

In yet another embodiment, the indication is provided in MSG4, which can be either in the MAC sub-header or the RRCRelease part of the message.

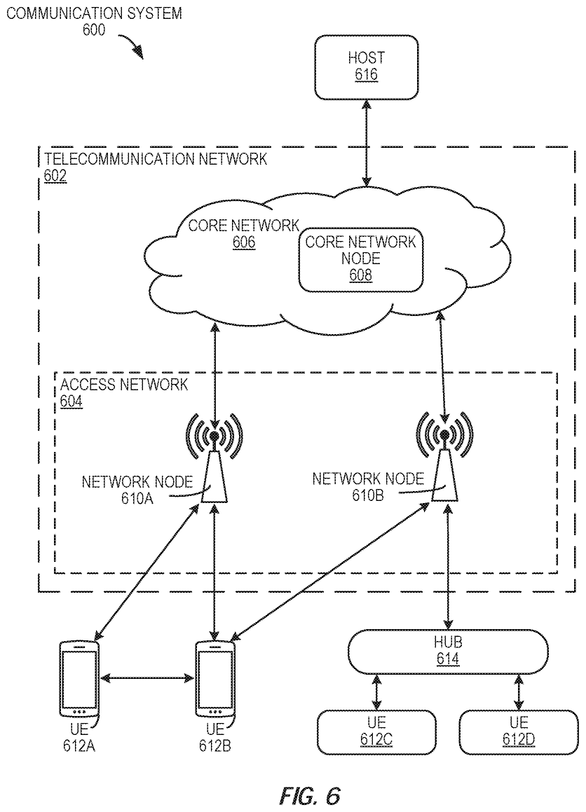

FIG. 6 shows an example of a communication system 600 in accordance with some embodiments.

In the example, the communication system 600 includes a telecommunication network 602 that includes an access network 604, such as a Radio Access Network (RAN), and a core network 606, which includes one or more core network nodes 608. The access network 604 includes one or more access network nodes, such as network nodes 610A and 610B (one or more of which may be generally referred to as network nodes 610), or any other similar Third Generation Partnership Project (3GPP) access node or non-3GPP Access Point (AP). The network nodes 610 facilitate direct or indirect connection of User Equipment (UE), such as by connecting UEs 612A, 612B, 612C, and 612D (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602 and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system 600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 602 is a cellular network that implements 3GPP standardized features. Accordingly, the telecommunication network 602 may support network slicing to provide different logical networks to different devices that are connected to the telecommunication network 602. For example, the telecommunication network 602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality (VR) headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and the network node 610B, but which is additionally capable of operating as a communication start and/or end point for certain data channels.

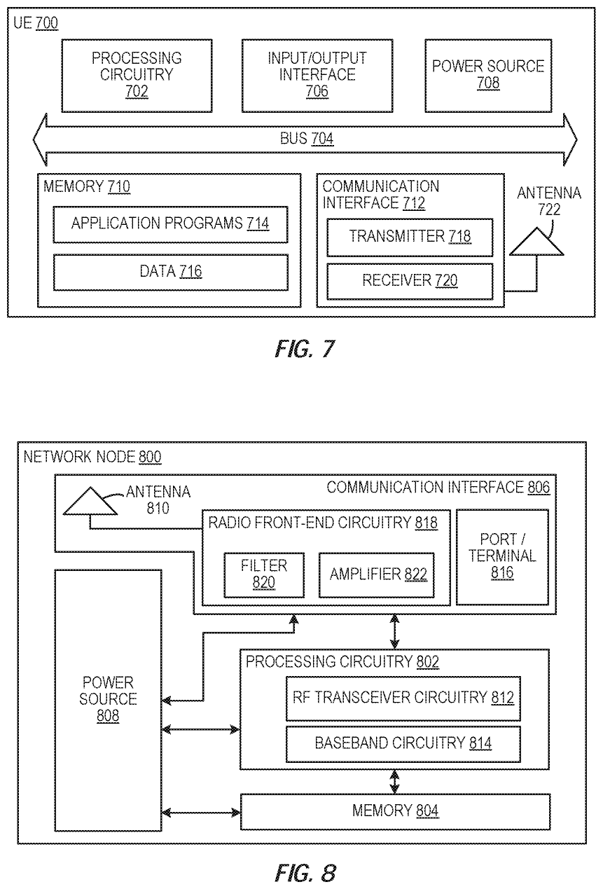

FIG. 7 shows a UE 700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 702 may include multiple Central Processing Units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging the power source 708. Power circuitry may perform any formatting, converting, or other modification to the power from the power source 708 to make the power suitable for the respective components of the UE 700 to which power is supplied.

The memory 710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 710 may allow the UE 700 to access instructions, application programs, and the like stored on transitory or non-transitory memory media, to off-load data, or to upload data. An article of manufacture, such as one utilizing a communication system, may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., the antenna 722) and may share circuit components, software, or firmware, or alternatively be implemented separately.

In the illustrated embodiment, communication functions of the communication interface 712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 8 shows a network node 800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, memory 804, a communication interface 806, and a power source 808. The network node 800 may be composed of multiple physically separate components (e.g., a Node B component and an RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 800 may be configured to support multiple RATs. In such embodiments, some components may be duplicated (e.g., separate memory 804 for different RATs) and some components may be reused (e.g., an antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 800.

The processing circuitry 802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 800 components, such as the memory 804, to provide network node 800 functionality.

In some embodiments, the processing circuitry 802 includes a System on a Chip (SOC). In some embodiments, the processing circuitry 802 includes one or more of Radio Frequency (RF) transceiver circuitry 812 and baseband processing circuitry 814. In some embodiments, the RF transceiver circuitry 812 and the baseband processing circuitry 814 may be on separate chips (or sets of chips), boards, or units, such as radio units and digital units. In alternative embodiments, part or all of the RF transceiver circuitry 812 and the baseband processing circuitry 814 may be on the same chip or set of chips, boards, or units.

The memory 804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and the memory 804 are integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. The radio front-end circuitry 818 comprises filters 820 and amplifiers 822. The radio front-end circuitry 818 may be connected to the antenna 810 and the processing circuitry 802. The radio front-end circuitry 818 may be configured to condition signals communicated between the antenna 810 and the processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of the filters 820 and/or the amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface 806 may comprise different components and/or different combinations of components.

In certain alternative embodiments, the network node 800 does not include separate radio front-end circuitry 818; instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes the one or more ports or terminals 816, the radio front-end circuitry 818, and the RF transceiver circuitry 812 as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, the communication interface 806, and/or the processing circuitry 802 may be configured to perform any receiving operations and/or certain obtaining operations described herein as being performed by the network node 800. Any information, data, and/or signals may be received from a UE, another network node, and/or any other network equipment. Similarly, the antenna 810, the communication interface 806, and/or the processing circuitry 802 may be configured to perform any transmitting operations described herein as being performed by the network node 800. Any information, data, and/or signals may be transmitted to a UE, another network node, and/or any other network equipment.

The power source 808 provides power to the various components of the network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid or an electricity outlet) via input circuitry or an interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

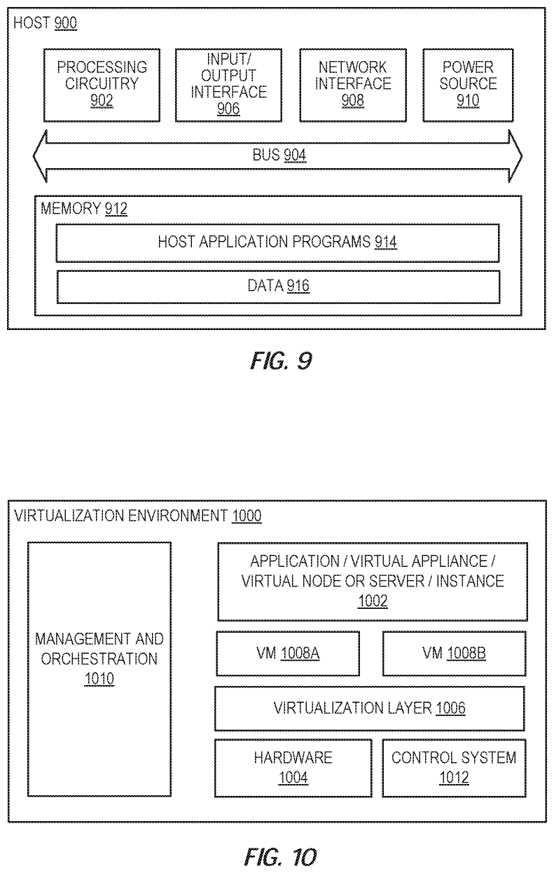

FIG. 9 is a block diagram of a host 900, which may be an embodiment of the host 616 of FIG. 6, in accordance with various aspects described herein. As used herein, the host 900 may be or comprise various combinations of hardware and/or software including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and memory 912. Other components may be included in other embodiments. Features of these components may be substantially similar to those described with respect to the devices of previous figures, such as FIGS. 7 and 8, such that the descriptions thereof are generally applicable to the corresponding components of the host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 914 may also provide for user authentication and licensing checks and may periodically report health, routes, and content availability to a central node, such as a device in or on the edge of a core network. Accordingly, the host 900 may select and/or indicate a different host for Over-The-Top (OTT) services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

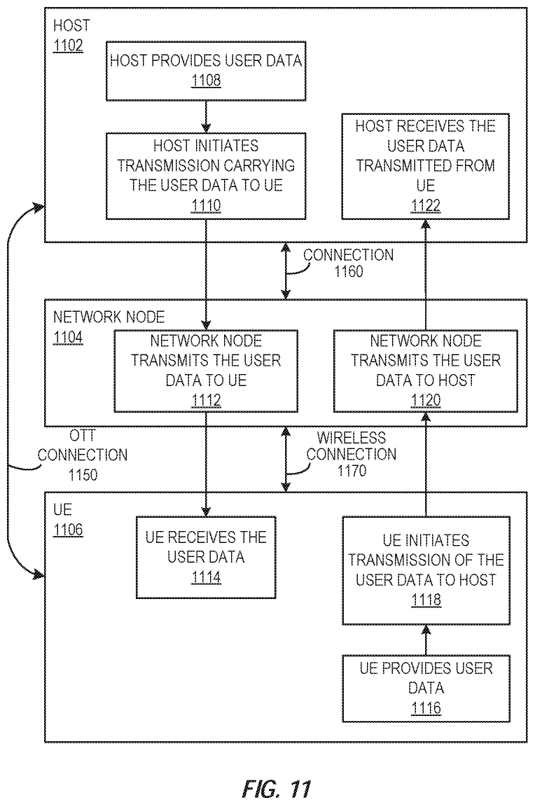

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or VM Monitors (VMMs)), provide VMs 1008A and 1008B (one or more of which may be generally referred to as VMs 1008), and/or perform any of the functions, features, and/or benefits described in relation with some embodiments described herein. The virtualization layer 1006 may present a virtual operating platform that appears like networking hardware to the VMs 1008.

The VMs 1008 comprise virtual processing, virtual memory, virtual networking, or interface and virtual storage, and may be run by a corresponding virtualization layer 1006. Different embodiments of the instance of a virtual appliance 1002 may be implemented on one or more of the VMs 1008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1008 may be a software implementation of a physical machine that runs programs as if they were executing on a physical, non-virtualized machine. Each of the VMs 1008, and that part of the hardware 1004 that executes that VM, be it hardware dedicated to that VM and/or hardware shared by that VM with others of the VMs 1008, forms separate virtual network elements. Still in the context of NFV, a virtual network function is responsible for handling specific network functions that run in one or more VMs 1008 on top of the hardware 1004 and corresponds to the application 1002.

The hardware 1004 may be implemented in a standalone network node with generic or specific components. The hardware 1004 may implement some functions via virtualization. Alternatively, the hardware 1004 may be part of a larger cluster of hardware (e.g., such as in a data center or CPE) where many hardware nodes work together and are managed via management and orchestration 1010, which, among others, oversees lifecycle management of the applications 1002. In some embodiments, the hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1012 which may alternatively be used for communication between hardware nodes and radio units.

FIG. 11 shows a communication diagram of a host 1102 communicating via a network node 1104 with a UE 1106 over a partially wireless connection in accordance with some embodiments. Example implementations, in accordance with various embodiments, of the UE (such as the UE 612A of FIG. 6 and/or the UE 700 of FIG. 7), the network node (such as the network node 610A of FIG. 6 and/or the network node 800 of FIG. 8), and the host (such as the host 616 of FIG. 6 and/or the host 900 of FIG. 9) discussed in the preceding paragraphs will now be described with reference to FIG. 11.

Like the host 900, embodiments of the host 1102 include hardware, such as a communication interface, processing circuitry, and memory. The host 1102 also includes software, which is stored in or is accessible by the host 1102 and executable by the processing circuitry. The software includes a host application that may be operable to provide a service to a remote user, such as the UE 1106 connecting via an OTT connection 1150 extending between the UE 1106 and the host 1102. In providing the service to the remote user, a host application may provide user data which is transmitted using the OTT connection 1150.

The network node 1104 includes hardware enabling it to communicate with the host 1102 and the UE 1106 via a connection 1160. The connection 1160 may be direct or pass through a core network (like the core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by the UE 1106 and executable by the UE's processing circuitry. The software includes a client application, such as a web browser or operator-specific “app” that may be operable to provide a service to a human or non-human user via the UE 1106 with the support of the host 1102. In the host 1102, an executing host application may communicate with the executing client application via the OTT connection 1150 terminating at the UE 1106 and the host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via the connection 1160 between the host 1102 and the network node 1104 and via a wireless connection 1170 between the network node 1104 and the UE 1106 to provide the connection between the host 1102 and the UE 1106. The connection 1160 and the wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104 in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR, or AR which it can broadcast, multicast, or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1150 between the host 1102 and the UE 1106 in response to variations in the measurement results. The measurement procedure and/or the network functionality for reconfiguring the OTT connection 1150 may be implemented in software and hardware of the host 1102 and/or the UE 1106. In some embodiments, sensors (not shown) may be deployed in or in association with other devices through which the OTT connection 1150 passes; the sensors may participate in the measurement procedure by supplying values of the monitored quantities exemplified above, or by supplying values of other physical quantities from which software may compute or estimate the monitored quantities. The reconfiguring of the OTT connection 1150 may include message format, retransmission settings, preferred routing, etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency, and the like by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

### Embodiments

### Group A Embodiments

Embodiment 1: A method performed by a User Equipment, UE, (612) for implementing Discontinuous Reception, DRX, the method comprising one or more of: configuring a DRX scheme which is activated in certain conditions; implementing DRX at the UE (612) from the time the UE (612) receives an RRCRelease message; implementing DRX at the UE (612) after the UE (612) receives DL data; implementing DRX at the UE (612) until terminating a Mobile Terminated-Small Data Transmission, MT-SDT, session; and switching back to idle mode immediately after sending a Hybrid Automatic Repeat Request Acknowledgment, HARQ-ACK, in response to the receipt of the RRCRelease message.

Embodiment 2: The method of the previous embodiment wherein the DRX configuration is applied from the time the UE receives the RRCRelease message until the connection is closed.

Embodiment 3: The method of any of the previous embodiments wherein the DRX configuration (e.g., the DRX-Config information element) is carried in the RRCRelease message.

Embodiment 4: The method of any of the previous embodiments wherein the DRX configuration is applied from the time the first DL data is received by the UE.

Embodiment 5: The method of any of the previous embodiments wherein the DRX configuration is carried in a RRCmessage.

Embodiment 6: The method of the previous embodiment wherein the RRCmessage is new.

Embodiment 7: The method of the previous two embodiments wherein the RRCmessage is multiplexed with the MAC PDU carrying the DL data.

Embodiment 8: The method of any of the previous embodiments wherein the DRX configuration is part of System Information, SI.

Embodiment 9: The method of any of the previous embodiments wherein the DRX configuration is contained in the UE context which was saved the previous time when the UE was sent to inactive state.

Embodiment 10: The method of any of the previous embodiments wherein the UE adjusts its DRX preferences based on its energy-related or traffic-related conditions.

Embodiment 11: The method of the previous embodiment further comprising: informing the network of the adjusted DRX preferences (e.g., as part of UEAssistanceInformation).

Embodiment 12: The method of any of the previous embodiments wherein the DRX preferences are based on one or more parameters such as: the UEs battery status and/or latency preferences.

Embodiment 13: The method of any of the previous embodiments wherein the DRX preferences are based on one or more parameters such as: the expected or historical behavior of the application, and the traffic patterns generated.

Embodiment 14: The method of any of the previous embodiments wherein the UEAssistanceInformation is sent to the gNB (610) either: multiplexed with the RRCResumeRequest; or in a scheduled transmission after the reception of the first DL data.

Embodiment 15: The method of any of the previous embodiments wherein sending of UEAssistanceInformation is triggered by introducing an added bit along with DL data.

Embodiment 16: The method of any of the previous embodiments wherein the RRCRelease contains an acknowledgement of the preferred DRX configuration (e.g., in the UEAssistanceInformation message).

Embodiment 17: The method of any of the previous embodiments wherein the RRCRelease contains the DRX configuration.

Embodiment 18: The method of any of the previous embodiments further comprising: receiving an indication on the handling or status of DRX timers related to a DRX configuration (e.g., included as part of providing a DRX configuration; in RRCRelease; DCI; and/or MAC CE).

Embodiment 19: The method of any of the previous embodiments wherein the indication comprises one or more of the group consisting of: not starting (alt. start w 0 duration) the DRX inactivity timer after receiving the DL transmission that includes the indication; starting, with a zero duration, the DRX inactivity timer after receiving the DL transmission that includes the indication; and an alternative onDuration related to a single or alternative SDT DRX configuration.

Embodiment 20: The method of any of the previous embodiments wherein the DRX configuration is provided by the gNB (610) in RRC Release (or another RRC message) during a previous connection (or when ending the previous connection).

Embodiment 21: The method of any of the previous embodiments wherein the DRX configuration is triggered to be activated by the UE during the MT-SDT procedure (e.g., using signaling from the gNB (610), for example, by using a DCI, MAC CE or RRC signaling or another form signaling).

Embodiment 22: The method of any of the previous embodiments wherein the UE is configured to always use DRX during MT-SDT (e.g., through dedicated RRC configuration or broadcast system information).

Embodiment 23: The method of any of the previous embodiments wherein the DRX configuration to be used is the same DRX configuration used in RRC_CONNECTED.

Embodiment 24: The method of any of the previous embodiments wherein a new DRX configuration is to be used only during the MT-SDT procedure or during the steps while waiting for the connection to be closed.

Embodiment 25: The method of any of the previous embodiments wherein the UE moves to idle mode as soon as the UE transmits the HARQ ACK in the uplink.

Embodiment 26: The method of any of the previous embodiments wherein the gNB (610) indicates to the UE that when it is for SDT, the UE may assume that it would be enough to respond with HARQ ACK in the uplink before moving to idle mode (e.g., without waiting further in case it receives a request for PDCP status report).

Embodiment 27: The method of any of the previous embodiments wherein such indication is provided along with the indication for MT-EDT in the paging message or in the control channel that schedules the paging message.

Embodiment 28: The method of any of the previous embodiments wherein the indication is provided in one or more of: MSG2 if it would be possible for the network to know that connection to be established is for MT-EDT (e.g., in case the UE uses preambles that are reserved for MT-EDT); as part of the system information broadcast in the serving cell; and in MSG4, which can be either in the MAC sub-header or the RRCRelease part of the message.

Embodiment 29: The method of any of the previous embodiments, further comprising: providing user data; and forwarding the user data to a host via the transmission to the network node (610).

### Group B Embodiments

Embodiment 30: A method performed by a network node (e.g., gNB) (610) for implementing Discontinuous Reception, DRX, in a User Equipment, UE, (612), the method comprising one or more of: deciding a DRX configuration for the UE; configuring the DRX scheme which is activated in certain conditions; implementing DRX at the UE (612) from the time the UE (612) receives an RRCRelease message; implementing DRX at the UE (612) after the UE (612) receives DL data; implementing DRX at the UE (612) until terminating a Mobile Terminated-Small Data Transmission, MT-SDT, session; and switching back to idle mode immediately after sending a Hybrid Automatic Repeat Request Acknowledgment, HARQ-ACK, in response to the receipt of the RRCRelease message.

Embodiment 31: The method of the previous embodiment wherein the DRX configuration is based on actual traffic.

Embodiment 32: The method of any of the previous embodiments further comprising: adjusting the UL grant scheduling based on the DRX preferences at the UE.

Embodiment 33: The method of the previous embodiment wherein the DRX configuration is applied from the time the UE receives the RRCRelease message until the connection is closed.

Embodiment 34: The method of any of the previous embodiments wherein the DRX configuration (e.g., the DRX-Config information element) is carried in the RRCRelease message.

Embodiment 35: The method of any of the previous embodiments wherein the DRX configuration is applied from the time the first DL data is received by the UE.

Embodiment 36: The method of any of the previous embodiments wherein the DRX configuration is carried in a RRCmessage.

Embodiment 37: The method of the previous embodiment wherein the RRCmessage is new.

Embodiment 38: The method of the previous two embodiments wherein the RRCmessage is multiplexed with the MAC PDU carrying the DL data.

Embodiment 39: The method of any of the previous embodiments wherein the DRX configuration is part of System Information, SI.

Embodiment 40: The method of any of the previous embodiments wherein the DRX configuration is contained in the UE context which was saved the previous time when the UE was sent to inactive state.

Embodiment 41: The method of any of the previous embodiments wherein the UE adjusts its DRX preferences based on its energy-related or traffic-related conditions.

Embodiment 42: The method of the previous embodiment further comprising: being informed of the adjusted DRX preferences (e.g., as part of UEAssistanceInformation).

Embodiment 43: The method of any of the previous embodiments wherein the DRX preferences are based on one or more parameters such as: the UEs battery status and/or latency preferences.

Embodiment 44: The method of any of the previous embodiments wherein the DRX preferences are based on one or more parameters such as: the expected or historical behavior of the application, and the traffic patterns generated.

Embodiment 45: The method of any of the previous embodiments wherein the UEAssistanceInformation is received by the gNB (610) either: multiplexed with the RRCResumeRequest; or in a scheduled transmission after the reception of the first DL data.

Embodiment 46: The method of any of the previous embodiments wherein sending of UEAssistanceInformation is triggered by introducing an added bit along with DL data.

Embodiment 47: The method of any of the previous embodiments wherein the RRCRelease contains an acknowledgement of the preferred DRX configuration (e.g., in the UEAssistanceInformation message).

Embodiment 48: The method of any of the previous embodiments wherein the RRCRelease contains the DRX configuration.

Embodiment 49: The method of any of the previous embodiments further comprising: transmitting an indication on the handling or status of DRX timers related to a DRX configuration (e.g., included as part of providing a DRX configuration; in RRCRelease; DCI; and/or MAC CE).

Embodiment 50: The method of any of the previous embodiments wherein the indication comprises one or more of the group consisting of: not starting (alt. start w 0 duration) the DRX inactivity timer after receiving the DL transmission that includes the indication; starting, with a zero duration, the DRX inactivity timer after receiving the DL transmission that includes the indication; and an alternative onDuration related to a single or alternative SDT DRX configuration.

Embodiment 51: The method of any of the previous embodiments wherein the DRX configuration is provided by the gNB (610) in RRC Release (or another RRC message) during a previous connection (or when ending the previous connection).

Embodiment 52: The method of any of the previous embodiments wherein the DRX configuration is triggered to be activated by the UE during the MT-SDT procedure (e.g., using signaling from the gNB (610), for example, by using a DCI, MAC CE or RRC signaling or another form signaling).

Embodiment 53: The method of any of the previous embodiments wherein the UE is configured to always use DRX during MT-SDT (e.g., through dedicated RRC configuration or broadcast system information).

Embodiment 54: The method of any of the previous embodiments wherein the DRX configuration to be used is the same DRX configuration used in RRC_CONNECTED.

Embodiment 55: The method of any of the previous embodiments wherein a new DRX configuration is to be used only during the MT-SDT procedure or during the steps while waiting for the connection to be closed.

Embodiment 56: The method of any of the previous embodiments wherein the UE moves to idle mode as soon as the UE transmits the HARQ ACK in the uplink.

Embodiment 57: The method of any of the previous embodiments wherein the gNB (610) indicates to the UE that when it is for SDT, the UE may assume that it would be enough to respond with HARQ ACK in the uplink before moving to idle mode (e.g., without waiting further in case it receives a request for PDCP status report).

Embodiment 58: The method of any of the previous embodiments wherein such indication is provided along with the indication for MT-EDT in the paging message or in the control channel that schedules the paging message.

Embodiment 59: The method of any of the previous embodiments wherein the indication is provided in one or more of: MSG2 if it would be possible for the network to know that connection to be established is for MT-EDT (e.g., in case the UE uses preambles that are reserved for MT-EDT); as part of the system information broadcast in the serving cell; and in MSG4, which can be either in the MAC sub-header or the RRCRelease part of the message.

Embodiment 60: The method of any of the previous embodiments, further comprising: obtaining user data; and forwarding the user data to a host or a user equipment.

### Group C Embodiments

Embodiment 61: A user equipment for implementing Discontinuous Reception, DRX, comprising: processing circuitry configured to perform any of the steps of any of the Group A embodiments; and power supply circuitry configured to supply power to the processing circuitry.

Embodiment 62: A network node (e.g., gNB) (610) for implementing Discontinuous Reception, DRX, in a User Equipment, UE, (612), the network node comprising: processing circuitry configured to perform any of the steps of any of the Group B embodiments; power supply circuitry configured to supply power to the processing circuitry.

Embodiment 63: A user equipment (UE) for implementing Discontinuous Reception, DRX, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 64: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 65: The host of the previous embodiment, wherein the cellular network further includes a network node (610) configured to communicate with the UE to transmit the user data to the UE from the host.

Embodiment 66: The host of the previous 2 embodiments, wherein: the processing circuitry of the host is configured to execute a host application, thereby providing the user data; and the host application is configured to interact with a client application executing on the UE, the client application being associated with the host application.

Embodiment 67: A method implemented by a host operating in a communication system that further includes a network node (610) and a user equipment (UE), the method comprising: providing user data for the UE; and initiating a transmission carrying the user data to the UE via a cellular network comprising the network node (610), wherein the UE performs any of the operations of any of the Group A embodiments to receive the user data from the host.

Embodiment 68: The method of the previous embodiment, further comprising: at the host, executing a host application associated with a client application executing on the UE to receive the user data from the UE.

Embodiment 69: The method of the previous embodiment, further comprising: at the host, transmitting input data to the client application executing on the UE, the input data being provided by executing the host application, wherein the user data is provided by the client application in response to the input data from the host application.

Embodiment 70: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 71: The host of the previous embodiment, wherein the cellular network further includes a network node (610) configured to communicate with the UE to transmit the user data from the UE to the host.

Embodiment 72: The host of the previous 2 embodiments, wherein: the processing circuitry of the host is configured to execute a host application, thereby providing the user data; and the host application is configured to interact with a client application executing on the UE, the client application being associated with the host application.

Embodiment 73: A method implemented by a host configured to operate in a communication system that further includes a network node (610) and a user equipment (UE), the method comprising: at the host, receiving user data transmitted to the host via the network node by the UE, wherein the UE performs any of the steps of any of the Group A embodiments to transmit the user data to the host.

Embodiment 74: The method of the previous embodiment, further comprising: at the host, executing a host application associated with a client application executing on the UE to receive the user data from the UE.

Embodiment 75: The method of the previous embodiment, further comprising: at the host, transmitting input data to the client application executing on the UE, the input data being provided by executing the host application, wherein the user data is provided by the client application in response to the input data from the host application.

Embodiment 76: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 77: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 78: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 79: The method of the previous embodiment, further comprising, at the network node, transmitting the user data provided by the host for the UE.

Embodiment 80: The method of any of the previous 2 embodiments, wherein the user data is provided at the host by executing a host application that interacts with a client application executing on the UE, the client application being associated with the host application.

Embodiment 81: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 82: The communication system of the previous embodiment, further comprising: the network node; and/or the user equipment.

Embodiment 83: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 84: The host of the previous 2 embodiments, wherein: the processing circuitry of the host is configured to execute a host application, thereby providing the user data; and the host application is configured to interact with a client application executing on the UE, the client application being associated with the host application.

Embodiment 85: The host of the any of the previous 2 embodiments, wherein the initiating receipt of the user data comprises requesting the user data.

Embodiment 86: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 87: The method of the previous embodiment, further comprising at the network node, transmitting the received user data to the host.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a User Equipment, UE, for implementing Discontinuous Reception, DRX, the method comprising:
Configuring a DRX scheme which is activated in certain conditions;
Implementing DRX at the UE during one or more of the group consisting of:
From the time the UE receives an rrcrelease message;
After the UE receives DL data;
Until terminating a Mobile Terminated-Small Data Transmission, MT-SDT, session.

2. The method of claim 1 wherein the DRX configuration is applied from the time the UE receives the rrcrelease message until the connection is closed.

3. The method of claim 1 wherein the DRX configuration is carried in the rrcrelease message.

4. The method of claim 1 wherein the DRX configuration is applied from the time the first DL data is received by the UE.

5. The method of claim 1 wherein the DRX configuration is carried in a rrcmessage.

6. The method of claim 5 wherein the rrcmessage is new.

7. The method of claim 5 wherein the rrcmessage is multiplexed with the MAC PDU carrying the DL data.

8. The method of claim 1 wherein the DRX configuration is part of System Information, SI.

9. The method of claim 1 wherein the DRX configuration is contained in the UE context which was saved the previous time when the UE was sent to inactive state.

10. The method of claim 1 wherein the UE-adjusts its DRX preferences based on its energy-related or traffic-related conditions.

11-29. (canceled)

30. A method performed by a network node for implementing Discontinuous Reception, DRX, in a User Equipment, UE, the method comprising one or more of:
Deciding a DRX configuration for the UE;
Configuring the DRX scheme which is activated in certain conditions;
Implementing DRX at the UE during one or more of the group consisting of:
From the time the UE receives an rrcrelease message;
After the UE receives DL data;
Until terminating a Mobile Terminated-Small Data Transmission, MT-SDT, session.

31-59. (canceled)

60. A User Equipment, UE, for implementing Discontinuous Reception, DRX, the UE comprising processing circuitry and memory, the memory comprising instructions to cause the UE to:
Configure a DRX scheme which is activated in certain conditions;
Implement DRX at the UE during one or more of the group consisting of:
From the time the UE receives an rrcrelease message;
After the UE receives DL data;
Until terminating a Mobile Terminated-Small Data Transmission, MT-SDT, session.

61. (canceled)

62. A network node for implementing Discontinuous Reception, DRX, the network node comprising processing circuitry and memory, the memory comprising instructions to cause the network node to:
Decide a DRX configuration for the UE;
Configure the DRX scheme which is activated in certain conditions;
Implement DRX at the UE during one or more of the group consisting of:
From the time the UE receives an rrcrelease message;
After the UE receives DL data;
Until terminating a Mobile Terminated-Small Data Transmission, MT-SDT, session.

63. (canceled)

64. The UE of claim 60 wherein the DRX configuration is applied from the time the UE receives the rrcrelease message until the connection is closed.

65. The UE of claim 60 wherein the DRX configuration is carried in the rrcrelease message.

66. The UE of claim 60 wherein the DRX configuration is applied from the time the first DL data is received by the UE.

67. The UE of claim 60 wherein the DRX configuration is carried in a rrcmessage.

68. The UE of claim 67 wherein the rrcmessage is new.

69. The UE of claim 67 wherein the rrcmessage is multiplexed with the MAC PDU carrying the DL data.

70. The UE of claim 60 wherein the DRX configuration is part of System Information, SI.
